(19) United States
(12) Patent Application Publication
(10) Pub. No.: US 2015/0058249 A1
(43) Pub. Date: Feb. 26, 2015

(54) TALLYING APPARATUS, TALLYING SYSTEM, AND TALLYING METHOD

(71) Applicant: Toru AKUTSU, Kanagawa (JP)

(72) Inventor: Toru AKUTSU, Kanagawa (JP)

(73) Assignee: RICOH COMPANY, LTD., Tokyo (JP)

(21) Appl. No.: 14/462,696

(22) Filed: Aug. 19, 2014

(30) Foreign Application Priority Data
Aug. 23, 2013 (JP) 2013-173062

(51) Int. Cl. G06Q 10/06

(52) U.S. Cl. CPC G06Q 10/06
USPC 705/342

(57) ABSTRACT

A tallying apparatus includes a reception unit that receives process information regarding a process executed by an apparatus, an identification unit that identifies, based on the process information, an information group to which the process information belongs, and a tallying unit that tallies the process information according to a tallying rule that is stored in a tallying rule storage in association with the identified information group.

### CROSS-REFERENCE TO RELATED APPLICATION

The present application is based upon and claims the benefit of priority of Japanese Patent Application No. 2013-173062, filed on Aug. 23, 2013, the entire contents of which are incorporated herein by reference.

### BACKGROUND OF THE INVENTION

1. Field of the Invention

An aspect of this disclosure relates to a tallying apparatus, a tallying system, and a tallying method.

2. Description of the Related Art

When a job is executed on, for example, an image forming apparatus, log information for the job is generated. The log information is used, for example, to calculate charges for the use of the image forming apparatus or to manage the usage history of the image forming apparatus.

In related-art systems for managing log information, log information is processed in a fixed manner. For example, charges obtained based on log information are tallied (or totaled) for each user or each group (e.g., a section) that is predetermined and fixed (see, for example, Japanese Laid-Open Patent Publication NO. 2011-197721).

However, for a company that runs business worldwide, for example, it may be preferable to process log information in different manners at different local offices.

### SUMMARY OF THE INVENTION

In an aspect of this disclosure, there is provided a tallying apparatus including a reception unit that receives process information regarding a process executed by an apparatus, an identification unit that identifies, based on the process information, an information group to which the process information belongs, and a tallying unit that tallies the process information according to a tallying rule that is stored in a tallying rule storage in association with the identified information group.

### BRIEF DESCRIPTION OF THE DRAWINGS

FIG. 1 is a drawing illustrating an exemplary configuration of a tallying system according to a first embodiment;

FIG. 2 is a block diagram illustrating an exemplary hardware configuration of a tallying server according to the first embodiment;

FIG. 3 is a block diagram illustrating an exemplary functional configuration of a tallying system according to the first embodiment;

FIG. 4 is a flowchart illustrating an exemplary process performed by a tallying server according to the first embodiment;

FIG. 5 is a table illustrating an exemplary configuration of log information according to the first embodiment;

FIG. 6 is a table illustrating an exemplary configuration of a user group storage unit;

FIG. 7 is a table illustrating an exemplary configuration of a rule information storage unit;

FIG. 8 is a block diagram illustrating an exemplary functional configuration of a tallying system according to a second embodiment;

FIG. 9 is a flowchart illustrating an exemplary process performed by a tallying server according to the second embodiment;

FIG. 10 is a table illustrating an exemplary configuration of an apparatus group storage unit;

FIG. 11 is a block diagram illustrating an exemplary functional configuration of a tallying system according to a third embodiment;

FIG. 12 is a flowchart illustrating an exemplary process performed by a tallying server according to the third embodiment;

FIG. 13 is a table illustrating an exemplary configuration of an applied group storage unit;

FIG. 14 is a block diagram illustrating an exemplary functional configuration of a tallying system according to a fourth embodiment;

FIG. 15 is a flowchart illustrating an exemplary process performed by a tallying server according to the fourth embodiment;

FIG. 16 is a table illustrating an exemplary configuration of a management code storage unit; and

FIG. 17 is a table illustrating an exemplary configuration of log information according to the fourth embodiment.

### DESCRIPTION OF THE PREFERRED EMBODIMENTS

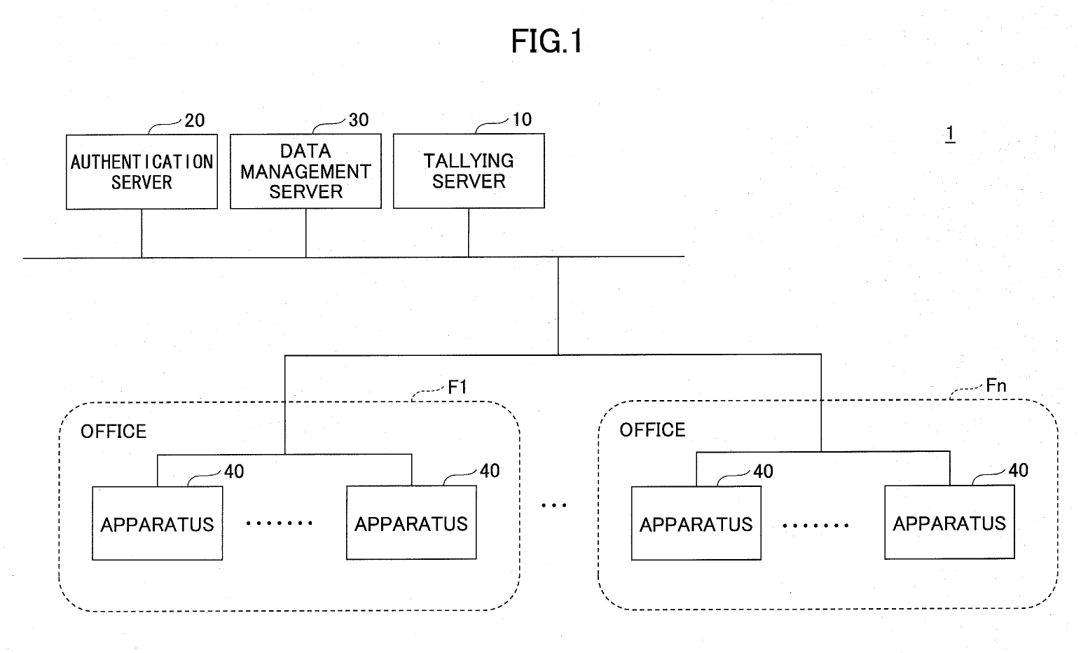

Preferred embodiments of the present invention are described below with reference to the accompanying drawings. FIG. 1 is a drawing illustrating an exemplary configuration of a tallying system 1 according to a first embodiment. In FIG. 1, for descriptive purposes, it is assumed that the tallying system 1 is a computer system being operated in a single company.

The tallying system 1 includes a tallying server 10, a data management server 30, and an authentication server 20 that are connected via a network such as a local area network (LAN) or a wide area network (WAN) to networks such as LANs of multiple offices F1 through Fn (which may be referred to as an “office F” or “offices F” when it is not necessary to distinguish between them).

The office F is an office of a company and may include one or more apparatuses 40. Each apparatus 40 can communicate with the tallying server 10 and the authentication server 20 via the network(s). The apparatus 40 may be, for example, an image forming apparatus such as a printer, a copier, a facsimile machine, or a multifunction peripheral. The apparatus 40 may also be a projector, a digital camera, or a teleconference system. In the present embodiment, the locations of the offices F are not limited to specific places. For example, the office F1 and the office Fn may be located in different countries or regions. Also, the office F may represent any unit or group of an organization. For example, the office F may represent a section, a floor, or a building of an organization.

The authentication server 20 may be implemented by one or more computers and performs authentication for operators of the apparatuses 40. The tallying server 10 may be implemented by one or more computers and receives log information from the apparatuses 40, and generates billing information based on the log information. The log information includes usage status information of the apparatus 40. The usage status information indicates, for example, the number of pages copied in a copy process and setting information or parameters (e.g., duplex, N-up processing, color, etc.) applied to the copy process. The billing information indicates a charge for the use of the apparatus 40 that is calculated based on the log information. The charge may be represented by a currency (i.e., an amount of money to be charged) or by the setting information included in the log information. That is, the charge may be represented by information based on which an amount of money to be charged can be calculated by using a predetermined function.

The data management server 30 may be implemented by one or more computers, and stores a history of log information and generated billing information. The authentication server 20, the tallying server 10, and the data management server 30 may be implemented by one computer or two or more separate computers.

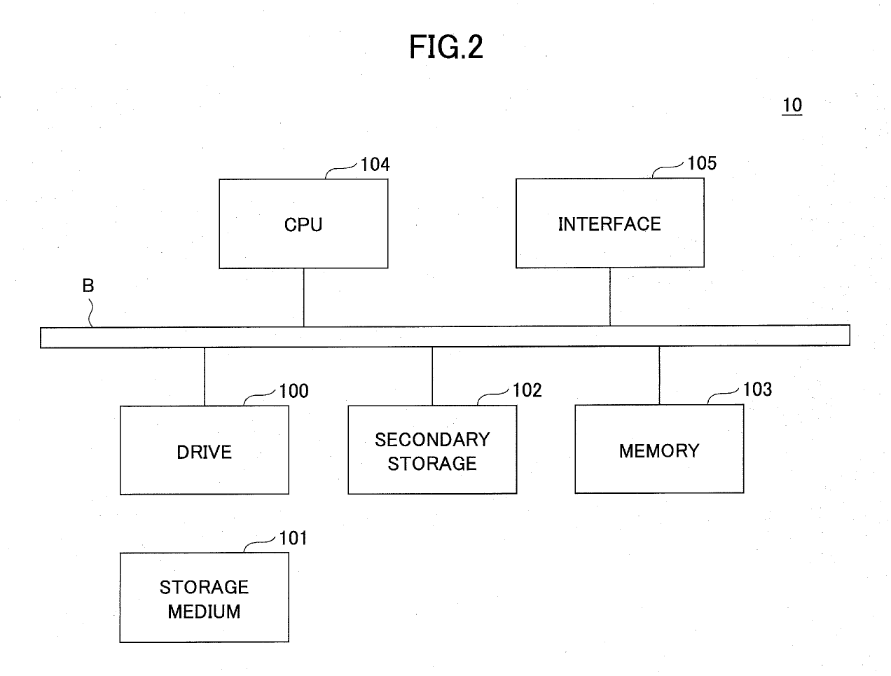

FIG. 2 is a block diagram illustrating an exemplary hardware configuration of the tallying server 10 according to the first embodiment. The authentication server 20, the data management server 30, and the apparatus 40 may also have a similar hardware configuration. As illustrated by FIG. 2, the tallying server 10 may include a drive 100, a secondary storage 102, a memory 103, a central processing unit (CPU) 104, and an interface 105 that are connected to each other via a bus B.

Programs for implementing various processes at the tallying server 10 may be provided via a storage medium 101 such as a CD-ROM. When the storage medium 101 storing programs is mounted on the drive 100, the programs are read by the drive 100 from the storage medium 101 and are installed in the secondary storage 102. Programs may not necessarily be installed from the storage medium 101. For example, programs may be downloaded via a network from another computer. The secondary storage 102 stores the installed programs and other necessary files and data.

The memory 103 temporarily stores programs read from the secondary storage 102 when the programs are executed. The CPU 104 performs functions of the tallying server 10 according to the programs temporarily stored in the memory 103. The interface 105 connects the tallying server 10 to a network.

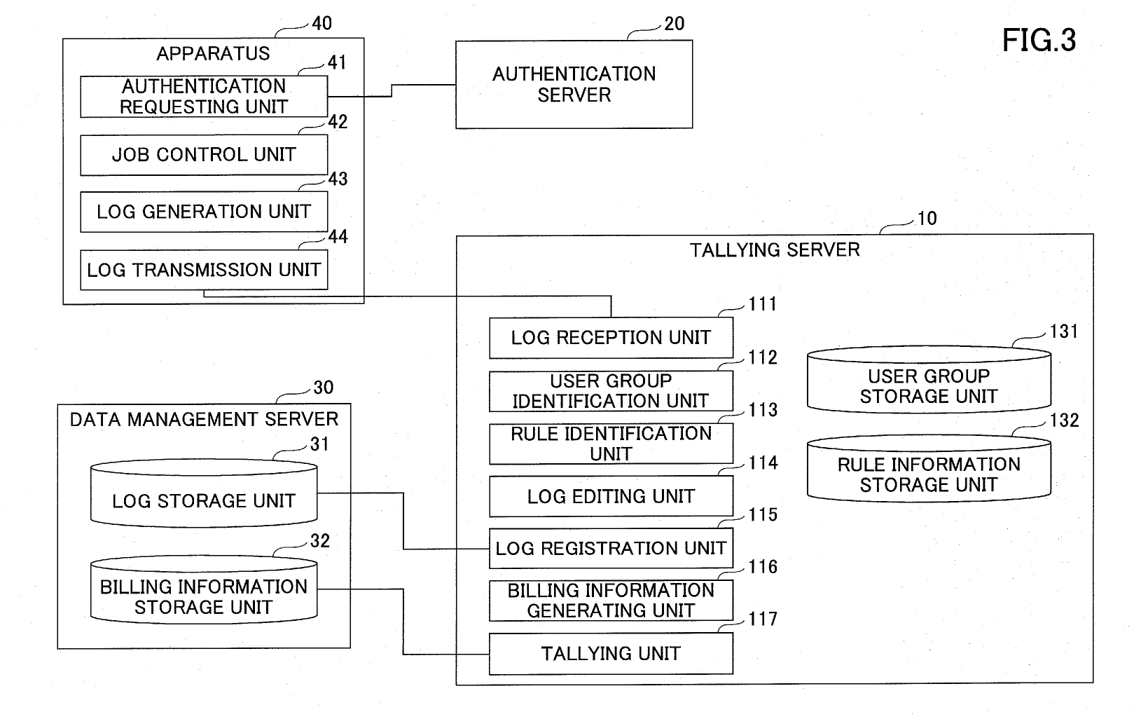

FIG. 3 is a block diagram illustrating an exemplary functional configuration of the tallying system 1 according to the first embodiment. As illustrated by FIG. 3, the apparatus 40 may include an authentication requesting unit 41, a job control unit 42, a log generation unit 43, and a log transmission unit 44. These units may be implemented by executing programs installed in the apparatus 40.

The authentication requesting unit 41 sends an authentication request to the authentication server 20 to request the authentication server 20 to perform authentication based of authentication information (e.g., a user ID and a password, or card information) input by a user (operator) of the apparatus 40, and receives an authentication result from the authentication server 20. The authentication request may be relayed by the tallying server 10 to the authentication server 20. In this case, the authentication requesting unit 41 may send the authentication request to the tallying server 10.

The job control unit 42 controls execution of jobs (processes) requested by an authenticated user. For example, the job control unit 42 controls execution of a print, scan, copy, or facsimile transmission job.

The log generation unit 43 generates log information for executed jobs. The log transmission unit 44 sends the generated log information to the tallying server 10.

The tallying server 10 may include a log reception unit 111, a user group identification unit 112, a rule identification unit 113, a log editing unit 114, a log registration unit 115, a billing information generating unit 116, and a tallying unit 117. These units are implemented by executing programs installed in the tallying server 10 by the CPU 104. The tallying server 10 may also include a user group storage unit 131 and a rule information storage unit 132. These storage units may be implemented, for example, by the secondary storage 102 and/or a storage device connected via a network to the tallying server 10.

The log reception unit 111 receives log information sent from the log transmission unit 44 of the apparatus 40. The user group identification unit 112 identifies a group (country, region, section, etc.) to which the user of the apparatus 40 belongs based on identification information (which is hereafter referred to as a “user ID”) of the user and information stored in the user group storage unit 131. Identifying a group to which the user of the apparatus 40 belongs is equivalent to identifying a group to which the received log information belongs. The user ID may be received together with the log information or included in the log information.

The user group storage unit 131 stores identification information (which is hereafter referred to as “group names”) of groups in association with user IDs. A group may be represented by, for example, a section (or department), a country, or a region. However, a group may not necessarily correspond to a part of the organization structure of a company. That is, groups may be freely defined by an administrator of the tallying system 1 so that charges are tallied for desired units (e.g., sections and users, which are hereafter referred to as “accounting units”).

The rule identification unit 113 identifies rule information indicating a rule(s) to be applied to the received log information by referring to the rule information storage unit 132 based on the group (group name) identified by the user group identification unit 112. The rule information storage unit 132 stores, in association with group names, rule information indicating rules to be applied to groups corresponding to the group names. The rule information includes an editing rule and a tallying rule.

The editing rule is a rule for editing log information. For example, an editing rule requests to mask (or make illegible) a particular item in log information. The editing rule is provided, for example, to make it difficult to identify a user (or employee) related to log information stored in the data management server 30 and thereby protect the user. For example, when a user ID is included in log information, the user ID is masked to identify the user related to the log information.

The tallying rule indicates an accounting unit for which billing information (or charges) is tallied. For example, charges may be tallied for each user or section (or department). When the accounting unit is a user, a billing destination that is to be billed is the user corresponding to a received user ID. When the accounting unit is a section, a billing destination is the section to which the user belongs. The billing destination here is used for management purposes, and the billing destination may not necessarily be actually billed. The tallying rule may be represented by information directly indicating a billing destination. For example, for a group, a number indicating a particular billing destination (e.g., identification information of a task or a project such as a management code in a fourth embodiment) may be stored as a tallying rule in the rule information storage unit 132.

The log editing unit 114 edits log information according to an editing rule identified by the rule identification unit 113. The log registration unit 115 registers log information edited by the log editing unit 114 in a log storage unit 31 of the data management server 30.

The billing information generating unit 116 generates billing information based on log information. For example, the billing information generating unit 116 calculates a charge as billing information by applying a predetermined function to setting information of a job included in log information. Alternatively, the billing information may be represented by log information itself. In this case, the billing information generating unit 116 may be omitted.

The tallying unit 117 tallies billing information (or charges) according to a tallying rule identified by the rule identification unit 113. More specifically, the tallying unit 117 adds a newly calculated charge (billing information) to a previous total charge (total billing information) stored in the data management server 30 in association with a billing destination that is identified based on the tallying rule.

The data management server 30 may include the log storage unit 31 and a billing information storage unit 32. The log storage unit 31 stores a history of log information. The billing information storage unit 32 stores a total charge (total billing information) for each accounting unit.

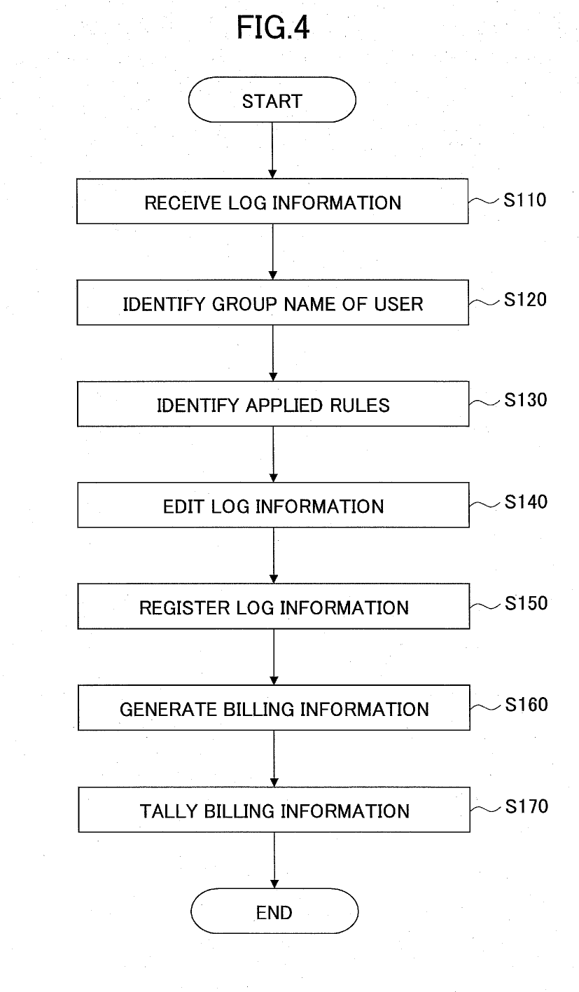

An exemplary process performed by the tallying server 10 is described below. FIG. 4 is a flowchart illustrating an exemplary process performed by the tallying server 10 according to the first embodiment.

At step S110, the log reception unit 111 receives log information sent from the apparatus 40.

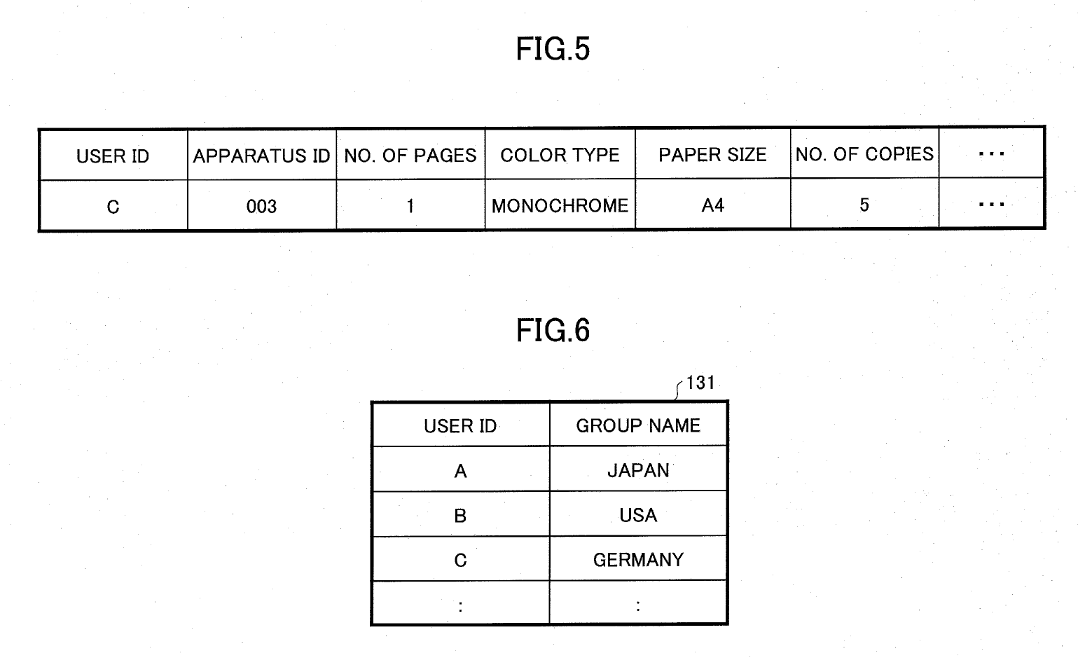

FIG. 5 is a table illustrating an exemplary configuration of log information according to the first embodiment. FIG. 5 illustrates exemplary log information for one job. As illustrated by FIG. 5, log information may include a user ID, an apparatus ID, a number of pages, a color type, a paper size, and a number of copies. The apparatus ID is identification information of the apparatus 40. The apparatus ID may be represented by any type of information that can be used to identify the apparatus 40. For example, a serial number or a production number of the apparatus 40 may be used as the apparatus ID. Alternatively, the apparatus ID may be represented by a value that is assigned to the apparatus 40 in the tallying system 1. Also, the apparatus ID may be represented by an IP address of the apparatus 40.

The log information of FIG. 5 indicates that in response to a request from a user C, five copies of one page of a document with a size A4 were printed in monochrome by an apparatus 40 with an apparatus ID “003”. Thus, the user ID in the log information identifies an operator or a user of the apparatus 40 (which is hereafter simply referred to as an “operator”). The apparatus ID in the log information identifies the apparatus 40 that has executed a job corresponding to the log information. Alternatively, the user ID and the apparatus ID may be received separately from the log information.

Next, the user group identification unit 112 identifies a group name of a group to which the user C belongs (or a group name of a group to which the log information belongs) based on the user ID in the log information (S120).

FIG. 6 is a table illustrating an exemplary configuration of the user group storage unit 131. As illustrated by FIG. 6, the user group storage unit 131 stores group names in association with user IDs of users in all of the offices F. In the example of FIG. 6, group names are represented by country names. However, as described above, group names may also be represented by any types of identification information identifying groups other than countries. Also, group names may be represented by information that is not understandable to the human being. For example, group names may be represented by a series of numerals or alphabet characters.

In this exemplary process, it is assumed that the group name “Germany” is identified for the user C. Here, in a case where a user ID includes a group name, the group name may be extracted directly from the user ID. In this case, the user group storage unit 131 may be omitted. In an exemplary user ID including a group name, a part of the user ID may indicate the group name and another part of the user ID may indicate identification information of a user.

Next, the rule identification unit 113 refers to the rule information storage unit 132 to identify rule information indicating rules to be applied to the group name “Germany” to which the user C belongs (S130).

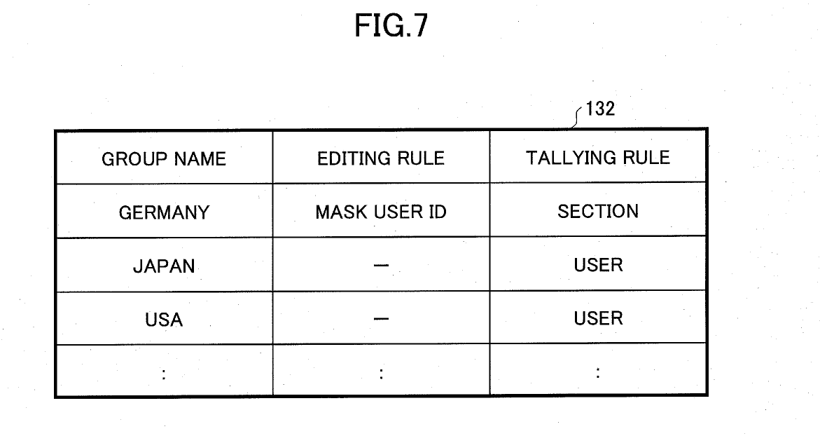

FIG. 7 is a table illustrating an exemplary configuration of the rule information storage unit 132. As illustrated by FIG. 7, the rule information storage unit 132 stores, in association with group names, editing rules and tallying rules. In FIG. 7, “mask user ID” in an editing rule field indicates that a user ID in log information is to be masked. On the other hand, a “-” (hyphen) in the editing rule field indicates that log information is not to be edited. In a tallying rule field in FIG. 7, “section” indicates that billing information (or charges) is tallied for each section or department to which the user belongs, and “user” indicates that billing information (or charges) is tallied for each user ID.

In this exemplary process, it is assumed that an editing rule and a tallying rule corresponding to the group name “Germany” are identified. Hereafter, the identified editing rule and tallying rule are referred to as an “applied editing rule” and an “applied tallying rule”, respectively.

Next, the log editing unit 114 edits the log information according to the applied editing rule (S140). In this exemplary process, the user ID is masked. For example, the user ID is replaced with a character string such as “*****” to make it difficult to identify the user ID. When the applied editing rule indicates that no editing is performed, step S140 may be omitted. Below, for descriptive purposes, log information that has not been edited is also referred to as “edited log information”.

Next, the log registration unit 115 registers the edited log information in the log storage unit 31 of the data management server 30 (S150). Next, the billing information generating unit 116 generates billing information based on the log information (S160). Log information before editing may be used to generate the billing information. Also, as long as there is no problem in generating the billing information, edited log information may be used to generate the billing information.

Then, the tallying unit 117 tallies the generated billing information according to the applied tallying rule (S170). In this exemplary process, the tallying unit 117 adds a value represented by the generated billing information to a value stored in the billing information storage unit 32 in association with a section name of a section to which the user C belongs The section name of the section to which the user C belongs may be obtained, for example, from the authentication server 20 based on the user ID of the user C. In this case, the authentication server 20 may be configured to store section names for respective user IDs. On the other hand, when the operator of the apparatus 40 is a user A or a user B and the applied tallying rule is “user”, the tallying unit 117 adds a value represented by the generated billing information to a value stored in the billing information storage unit 32 for the user A or the user B.

As described above, the first embodiment makes it possible to use different rules depending on the group to which the user of the apparatus 40 belongs. That is, the first embodiment makes it possible to use different editing rules for editing log information and different tallying rules for tallying billing information depending on groups to which users belong. This in turn makes it possible to improve the flexibility in processing information regarding processes executed by the apparatus 40. In other words, the first embodiment makes it possible to use the same tallying server 10 to process log information sent from the apparatuses 40 in different offices F to which different editing rules and tallying rules are applied.

For example, according to the first embodiment, even when the user C belonging to “Germany” visits an office F belonging to “Japan” and uses the apparatus 40 in the office F, rule information for “Germany” is applied to log information related to the use of the apparatus 40.

Next, a second embodiment is described. Below, differences between the first and second embodiments are mainly described. Accordingly, configurations and methods of the second embodiment that are not described below may be substantially the same as those of the first embodiment.

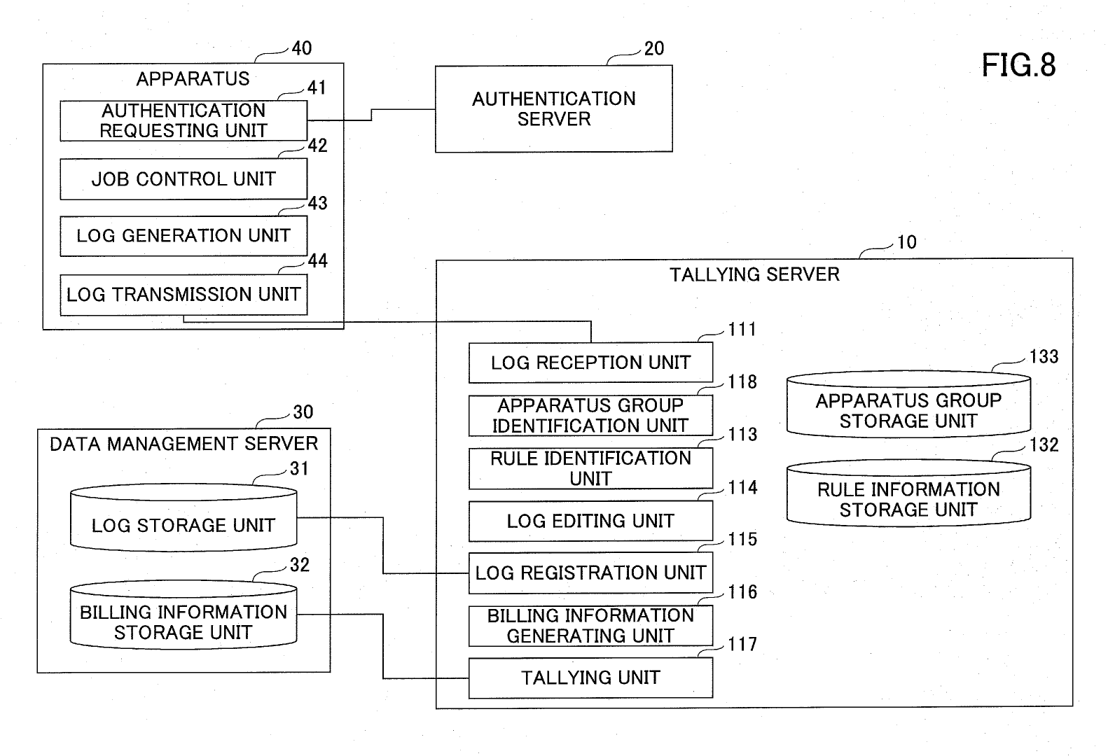

FIG. 8 is a block diagram illustrating an exemplary functional configuration of the tallying system 1 according to the second embodiment. The same reference numbers as in FIG. 3 are assigned to the corresponding components in FIG. 8, and descriptions of those components are omitted here.

In FIG. 8, the tallying server 10 includes an apparatus group identification unit 118 instead of the user group identification unit 112, and includes an apparatus group storage unit 133 instead of the user group storage unit 131.

The apparatus group identification unit 118 identifies a group to which the apparatus 40 belongs by referring to the apparatus group storage unit 133 based on an apparatus ID received from the apparatus 40. A group to which the apparatus 40 belongs indicates, for example, a country, a region, or a section where the apparatus 40 is located. Identifying a group to which the apparatus 40 belongs is equivalent to identifying a group to which log information received from the apparatus 40 belongs. The apparatus ID may be received together with the log information or included in the log information.

The apparatus group storage unit 133 stores group names in association with apparatus IDs.

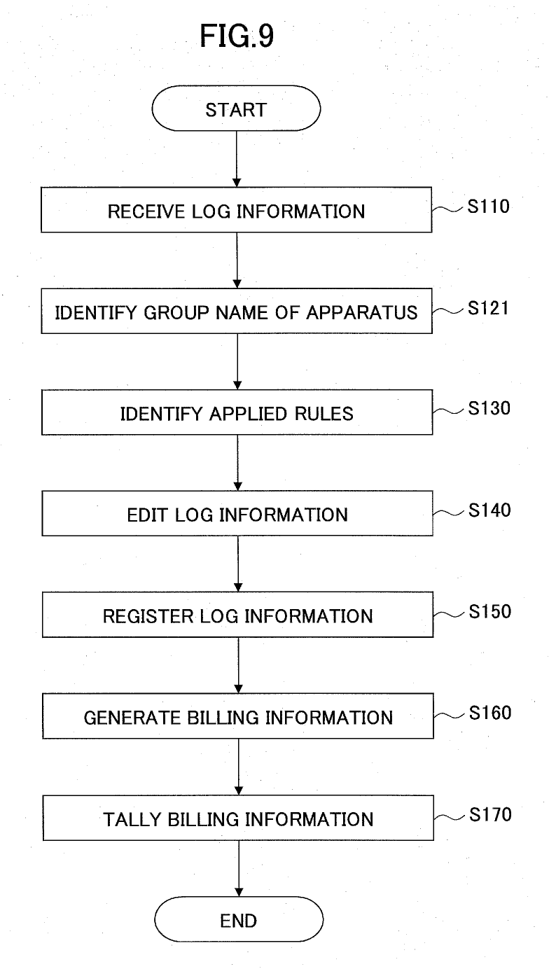

FIG. 9 is a flowchart illustrating an exemplary process performed by the tallying server 10 according to the second embodiment. The same reference numbers as in FIG. 4 are assigned to the corresponding steps in FIG. 9, and descriptions of those steps are omitted.

In FIG. 9, step S120 of FIG. 4 is replaced with step S121. At step S121, based on an apparatus ID included in log information, the apparatus group identification unit 118 identifies a group name of a group to which the apparatus 40 belongs (or a group name of a group to which the log information belongs).

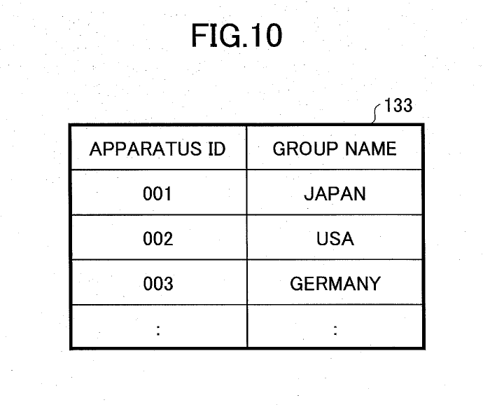

FIG. 10 is a table illustrating an exemplary configuration of the apparatus group storage unit 133. As illustrated by FIG. 10, the apparatus group storage unit 133 stores group names in association with apparatus IDs of the apparatuses 40 in all of the offices F.

Here, in a case where an apparatus ID includes a group name, the group name may be extracted directly from the apparatus ID. In this case, the apparatus group storage unit 133 may be omitted. In an exemplary apparatus ID including a group name, a part of the apparatus ID may indicate the group name and another part of the apparatus ID may indicate identification information of the apparatus 40.

Other steps in FIG. 9 are substantially the same as the corresponding steps in FIG. 4.

The second embodiment provides advantageous effects similar to those provided by the first embodiment. According to the second embodiment, for example, when the user C belonging to “Germany” visits an office F belonging to “Japan” and uses the apparatus 40 in the office F, rule information for “Japan” is applied to log information related to the use of the apparatus 40.

Next, a third embodiment is described. Below, differences from the first and second embodiments are mainly described. Accordingly, configurations and methods of the third embodiment that are not described below may be substantially the same as those of the first or second embodiment.

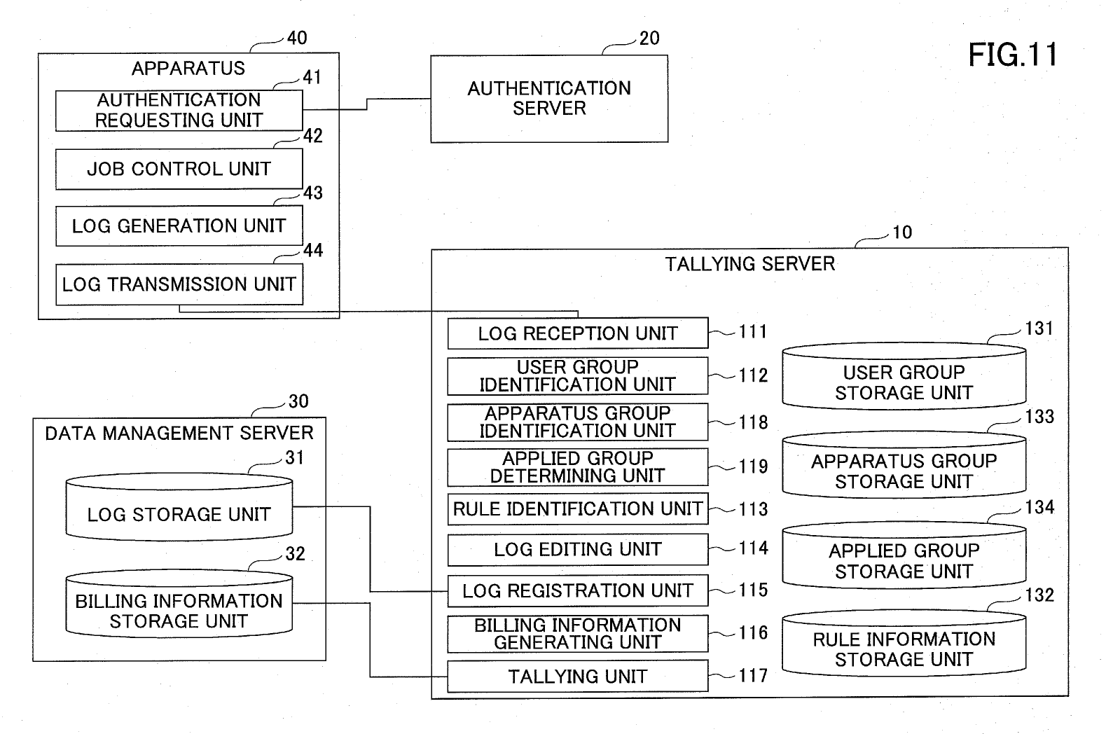

FIG. 11 is a block diagram illustrating an exemplary functional configuration of the tallying system 1 according to the third embodiment. The same reference numbers as in FIG. 3 or 8 are assigned to the corresponding components in FIG. 11, and descriptions of those components are omitted here.

In FIG. 11, the tallying server 10 includes both of the user group identification unit 112 and the apparatus group identification unit 118. Also, the tallying server 10 includes both of the user group storage unit 131 and the apparatus group storage unit 133. Further, the tallying server 10 includes an applied group determining unit 119 and an applied group storage unit 134. The applied group determining unit 119 determines whether a user (or an operator) is inside or outside of the location (group location) of a group to which the user belongs (e.g., whether the user is in a country, a region, or a section represented by the group), and determines an applied group based on which rule information is identified (i.e., a group that is applied to log information) by referring to the applied group storage unit 134 based on the result of determining whether the user is inside or outside of the group location. For example, the applied group determining unit 119 determines whether a group name of a group to which the user belongs needs to be applied to log information even when the user is outside of the group location. The applied group storage unit 134 stores information based on which the applied group determining unit 119 determines an applied group.

When the group name of the user matches the group name of the apparatus 40 that has sent the log information, the applied group determining unit 119 determines that the user is inside of the group location. On the other hand, when the group name of the user is different from the group name of the apparatus 40 that has sent the log information, the applied group determining unit 119 determines that the user is outside of the group location. Hereafter, “user status” indicates a status of the user that is determined based on the group name of the user and the group name of the apparatus 40 that has sent log information. For example, a user is outside of a group location when the user is on a business trip.

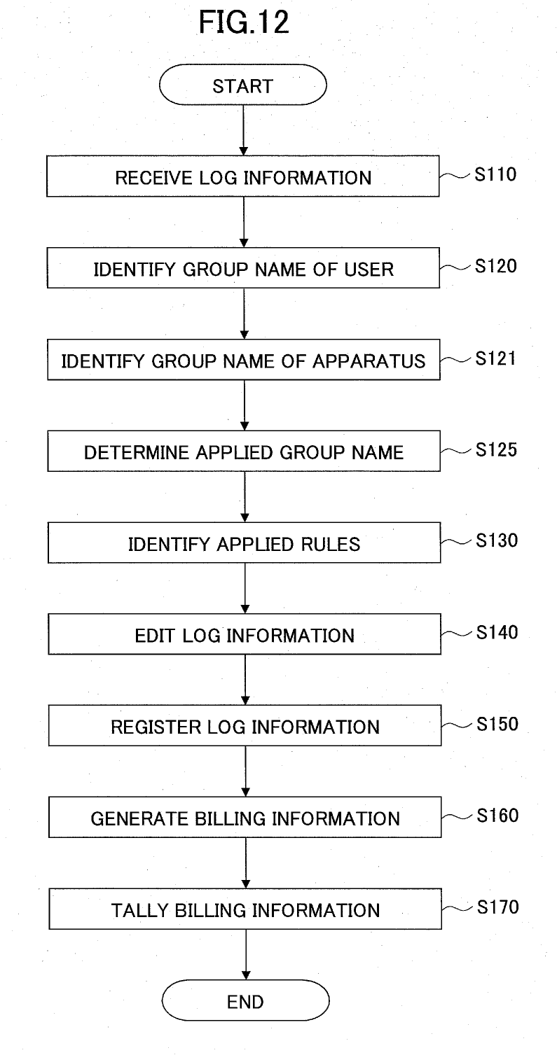

FIG. 12 is a flowchart illustrating an exemplary process performed by the tallying server 10 according to the third embodiment. The same reference numbers as in FIG. 4 or 9 are assigned to the corresponding steps in FIG. 12, and descriptions of those steps are omitted.

In FIG. 12, both of steps S120 and S121 are performed. Accordingly, in the process of FIG. 12, based on received log information, a group name (user group name) corresponding to the user (or operator) and a group name (apparatus group name) for the apparatus 40 that has sent the log information are identified.

Next, the applied group determining unit 119 compares the user group name with the apparatus group name, and determines an applied group to be applied to the log information by referring to the applied group storage unit 134 based on the comparison result (S125).

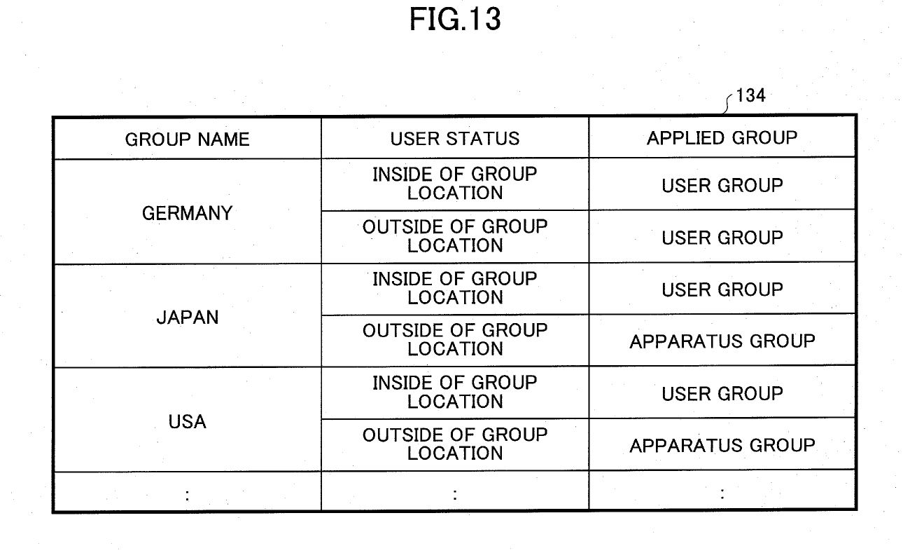

FIG. 13 is a table illustrating an exemplary configuration of the applied group storage unit 134. As illustrated by FIG. 13, the applied group storage unit 134 stores applied groups in association with group names and user status. The applied group determining unit 119 identifies a group name in the applied group storage unit 134 that corresponds to the user group name. Then, the applied group determining unit 119 determines the user status based on the result of comparing the user group name with the apparatus group name. The user status is “outside of group location” when the user group name is different from the apparatus group name, and the user status is “inside of group location” when the user group name matches the apparatus group name. The applied group determining unit 119 identifies an applied group that corresponds to the identified group name and the determined user status.

For example, when the operator of the apparatus 40 is the user C belonging to “Germany” and the group of the apparatus 40 is “Japan” (case 1), the applied group determining unit 119 identifies an applied group in a record where the group name is “Germany” and the user status is “outside of group location”.

The applied group is either “user group” or “apparatus group”. “User group” indicates that the user group name is applied to the log information. In case 1, “Germany” is applied to the log information. “Apparatus group” indicates that the apparatus group name is applied to the log information.

At step S130, the rule identification unit 130 identifies rule information that is stored in the rule information storage unit 132 (FIG. 7) in association with the applied group to be applied to the log information. Other steps in FIG. 12 are substantially the same as the corresponding steps in FIG. 4 or 9.

As described above, the third embodiment makes it possible to flexibly process log information on the use of an apparatus 40 depending on a user group to which a user belongs even when the user is, for example, on a business trip and the apparatus 40 is located outside of the location of the user group.

Next, a fourth embodiment is described. Below, differences between the first embodiment and the fourth embodiment are mainly described. Accordingly, configurations and methods of the fourth embodiment that are not described below may be substantially the same as those of the first embodiment.

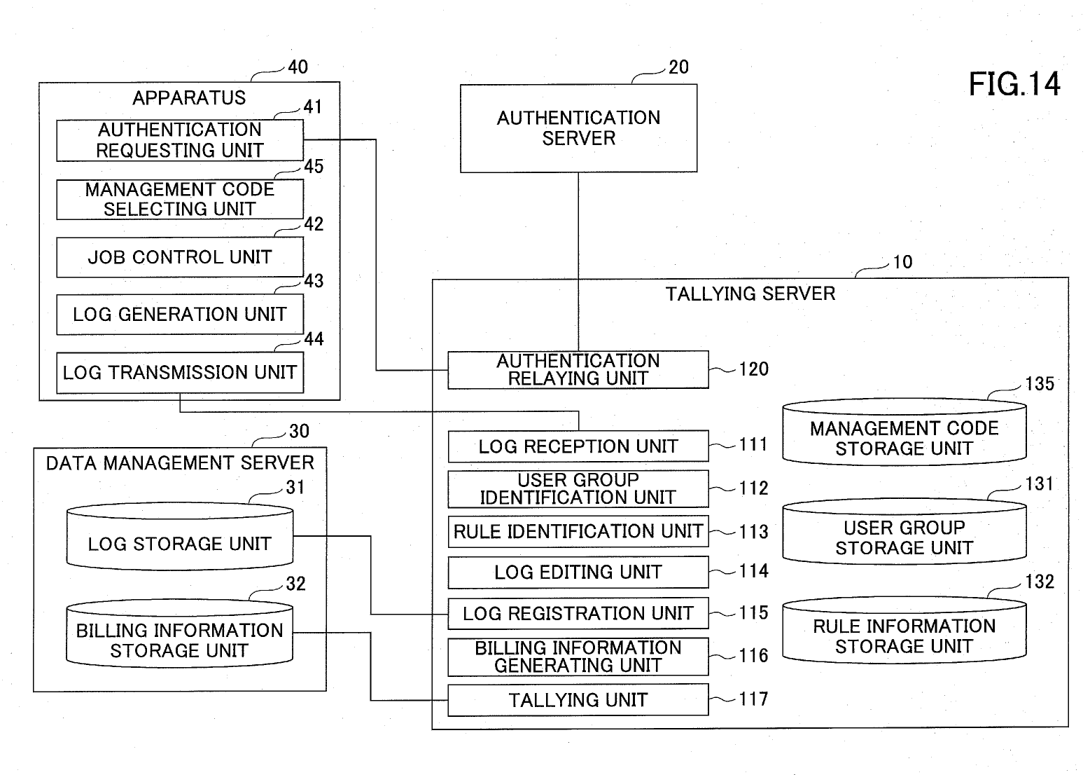

FIG. 14 is a block diagram illustrating an exemplary functional configuration of the tallying system 1 according to the fourth embodiment. The same reference numbers as in FIG. 3 are assigned to the corresponding components in FIG. 14, and descriptions of those components are omitted here.

In FIG. 14, the tallying server 10 includes an authentication relaying unit 120. The authentication relaying unit 120 receives an authentication request for an operator from the authentication requesting unit 41 of the apparatus 40, and transfers the authentication request to the authentication server 20. Also, the authentication relaying unit 120 sends an authentication result received from the authentication server 20 to the authentication requesting unit 41. When the authentication result received from the authentication server 20 indicates that the operator has been successfully authenticated, the authentication relaying unit 120 sends, together with the authentication result, a list of management codes that are stored in a management code storage unit 135 in association with the user ID of the authenticated operator to the authentication requesting unit 41. A management code is identification information for identifying, for example, a task or a project.

Also in FIG. 14, the apparatus 40 includes a management code selecting unit 45. The management code selecting unit 45 selects, according to an instruction from the operator, a management code from the list of management codes received from the authentication relaying unit 120. The selected management code is used in tallying charges. When a management code is selected, the selected management code is included in log information generated by the log generation unit 43.

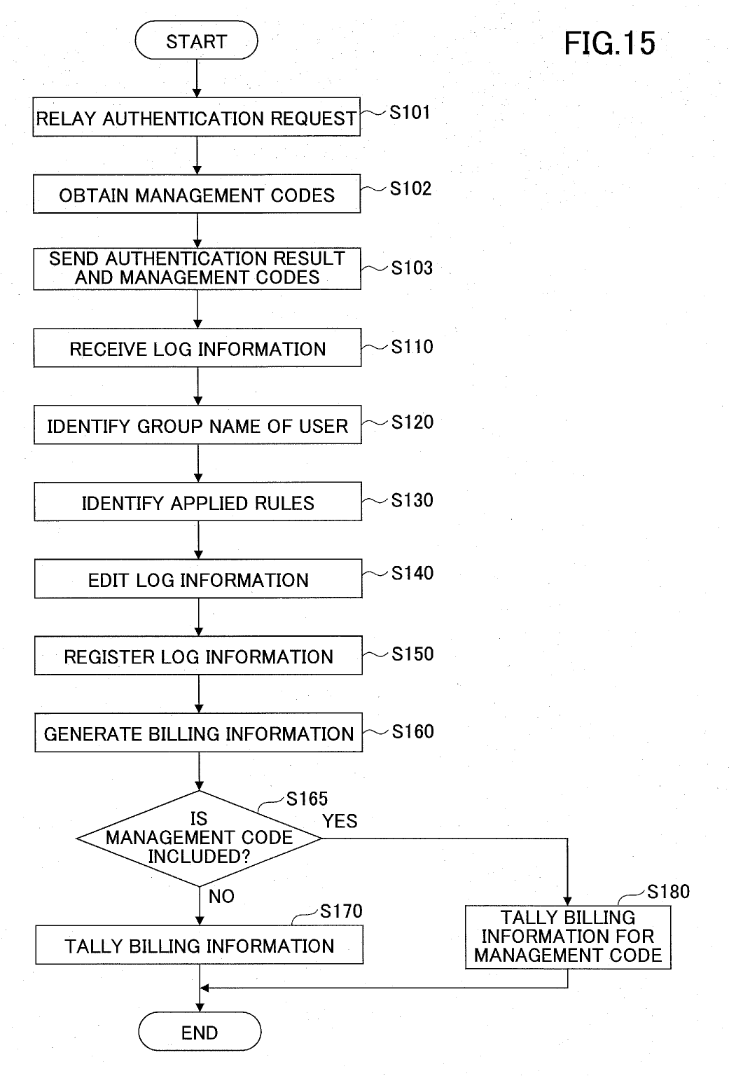

FIG. 15 is a flowchart illustrating an exemplary process performed by the tallying server 10 according to the fourth embodiment. The same reference numbers as in FIG. 4 are assigned to the corresponding steps in FIG. 15, and descriptions of those steps are omitted. In FIG. 15, steps S101 through S103, step S165, and step S180 are added to the process of FIG. 4.

At step S101, when receiving an authentication request from the authentication requesting unit 41 of the apparatus 40, the authentication relaying unit 120 performs an authentication relaying process. The authentication request includes, for example, a user ID and a password of an operator. In the authentication relaying process, the authentication relaying unit 120 transfers the authentication request to the authentication server 20 and receives an authentication result from the authentication server 20. When the operator is successfully authenticated, step S102 and subsequent steps are performed.

At step S102, the authentication relaying unit 120 obtains management codes associated with the user ID of the authenticated operator from the management code storage unit 135.

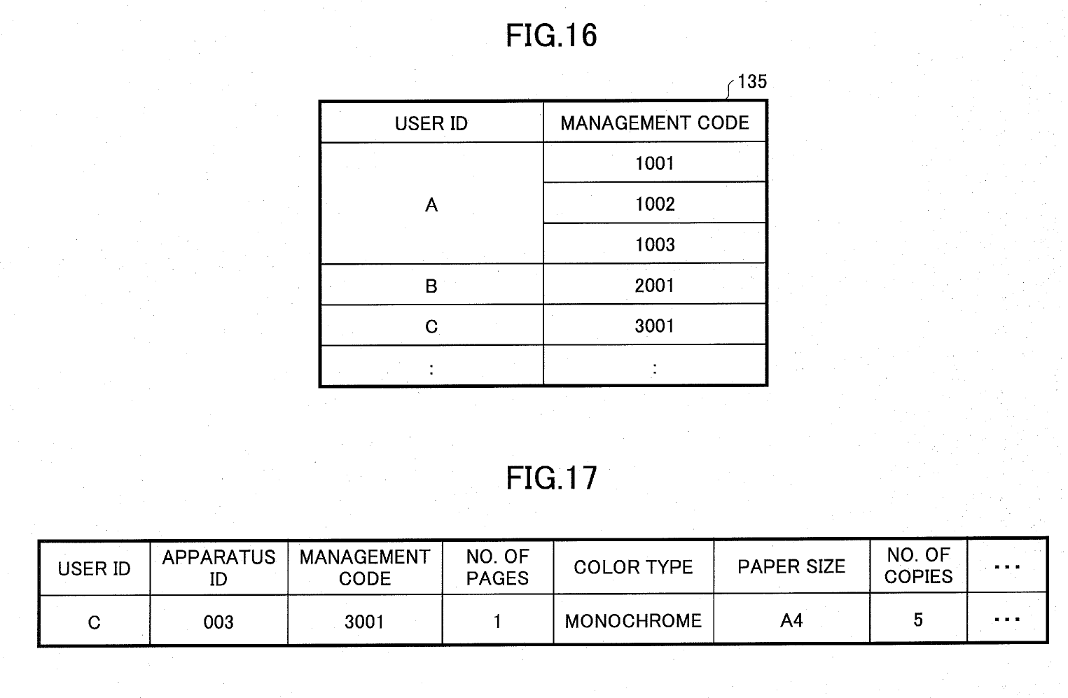

FIG. 16 is a table illustrating an exemplary configuration of the management code storage unit 135. As illustrated by FIG. 16, the management code storage unit 135 stores, in association with each user ID, one or more management codes that a user corresponding to the user ID can select. The management code storage unit 135 may not store a record for a user for which no selectable management code exists.

Next, the authentication relaying unit 120 sends the authentication result and a list of the obtained management codes to the authentication requesting unit 41 (S103). Here, when no management code exists for the operator, the authentication relaying unit 120 does not send the list of management codes to the authentication requesting unit 41.

When the authentication result indicating that the authentication has been successful and the list of management codes are received at the apparatus 40, the management code selecting unit 45 displays, on an operations panel of the apparatus 40, a management code selection screen including the management codes in the list as options. The management code selection screen also includes an option “Do Not Select Management Code”. When this option is selected, billing information is tallied according to a tallying rule defined in the rule information storage unit 132. The option “Do Not Select Management Code” is selected, for example, when the apparatus 40 is used for a task that is different from tasks corresponding to the management codes.

When a management code is selected, the log generation unit 43 generates log information including the selected management code for jobs that are performed after the selection of the management code.

FIG. 17 is a table illustrating an exemplary configuration of log information according to the fourth embodiment. FIG. 17 illustrates exemplary log information that is generated when a management code “3001” is selected.

At step S110, the log reception unit 111 receives log information as illustrated by FIG. 17. Steps S120 through S160 are substantially the same as those described in the first embodiment.

After step S160, the tallying unit 117 determines whether the log information includes a management code (S165). When no management code is included in the log information (NO at S165), the tallying unit 117 proceeds to step S170. At step S170, billing information is tallied according to a tallying rule stored in the rule information storage unit 132.

On the other hand, when a management code is included in the log information (YES at S165), the tallying unit 117 adds a value represented by billing information generated at step S160 to a value stored in the billing information storage unit 32 in association with the management code (S180).

For example, the fourth embodiment makes it possible to tally billing information (or charges) for a unit that involves different groups. The fourth embodiment may be combined with the second or third embodiment.

In the above embodiments, the services of the tallying server 10, the authentication server 20, and the data management server 30 may be provided as cloud services. In this case, the tallying server 10, the authentication server 20, and the data management server 30 may be used by multiple companies or organizations.

In the above embodiments, the tallying server 10 is an example of a tallying apparatus or a tallying system. Log information is an example of process information regarding a process executed by the apparatus 40. The rule information storage unit 132 is an example of a tallying rule storage. Each of or a combination of the user group identification unit 112, the apparatus group identification unit 118, and the applied group determining unit 119 is an example of an identification unit.

An aspect of this disclosure provides a tallying apparatus, a tallying system, and a tallying method that make it possible to improve the flexibility in processing information regarding processes executed by apparatuses.

A tallying apparatus, a tallying system, and a tallying method according to the embodiments of the present invention are described above. However, the present invention is not limited to the specifically disclosed embodiments, and variations and modifications may be made without departing from the scope of the present invention.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD-ROM, magnetic tape device or solid state memory device.

What is claimed is:

1. A tallying apparatus, comprising:
a reception unit that receives process information regarding a process executed by an apparatus;
an identification unit that identifies, based on the process information, an information group to which the process information belongs; and
a tallying unit that tallies the process information according to a tallying rule that is stored in a tallying rule storage in association with the identified information group.

2. The tallying apparatus as claimed in claim 1, wherein the identification unit identifies, as the information group, an operator group to which an operator of the apparatus belongs based on identification information of the operator that is received from the apparatus.

3. The tallying apparatus as claimed in claim 1, wherein the identification unit identifies, as the information group, an apparatus group to which the apparatus belongs based on identification information of the apparatus that is received from the apparatus.

4. The tallying apparatus as claimed in claim 1, wherein the identification unit includes
a first identification unit that identifies an operator group to which an operator of the apparatus belongs based on identification information of the operator that is received from the apparatus,
a second identification unit that identifies an apparatus group to which the apparatus belongs based on identification information of the apparatus that is received from the apparatus, and
a third identification unit that identifies the information group based on a result of comparing the operator group and the apparatus group.

5. The tallying apparatus as claimed in claim 1, wherein when identification information of a billing destination is received from the apparatus, the tallying unit tallies the process information for the billing destination.

6. A system implemented by one or more computers, the system comprising:
a reception unit that receives process information regarding a process executed by an apparatus;
an identification unit that identifies, based on the process information, an information group to which the process information belongs; and
a tallying unit that tallies the process information according to a tallying rule that is stored in a tallying rule storage in association with the identified information group.

7. The system as claimed in claim 6, wherein the identification unit identifies, as the information group, an operator group to which an operator of the apparatus belongs based on identification information of the operator that is received from the apparatus.

8. The system as claimed in claim 6, wherein the identification unit identifies, as the information group, an apparatus group to which the apparatus belongs based on identification information of the apparatus that is received from the apparatus.

9. The system as claimed in claim 6, wherein the identification unit includes
a first identification unit that identifies an operator group to which an operator of the apparatus belongs based on identification information of the operator that is received from the apparatus,
a second identification unit that identifies an apparatus group to which the apparatus belongs based on identification information of the apparatus that is received from the apparatus, and
a third identification unit that identifies the information group based on a result of comparing the operator group and the apparatus group.

10. The system as claimed in claim 6, wherein when identification information of a billing destination is received from the apparatus, the tallying unit tallies the process information for the billing destination.

11. A method performed by a computer, the method comprising:
receiving process information regarding a process executed by an apparatus;
identifying, based on the process information, an information group to which the process information belongs; and
tallying the process information according to a tallying rule that is stored in a tallying rule storage in association with the identified information group.

12. The method as claimed in claim 11, wherein in the identifying, an operator group to which an operator of the apparatus belongs is identified as the information group based on identification information of the operator that is received from the apparatus.

13. The method as claimed in claim 11, wherein in the identifying, an apparatus group to which the apparatus belongs is identified as the information group based on identification information of the apparatus that is received from the apparatus.

14. The method as claimed in claim 11, wherein the identifying includes
identifying an operator group to which an operator of the apparatus belongs based on identification information of the operator that is received from the apparatus,
identifying an apparatus group to which the apparatus belongs based on identification information of the apparatus that is received from the apparatus, and
identifying the information group based on a result of comparing the operator group and the apparatus group.

15. The method as claimed in claim 11, wherein in the tallying, when identification information of a billing destination is received from the apparatus, the process information is tallied for the billing destination.
